(19) United States
(12) Patent Application Publication
(10) Pub. No.: US 2007/0011068 A1
(43) Pub. Date: Jan. 11, 2007

(54) Method and system for net share settlement of a convertible bond

(76) Inventor: Jeffrey J. Zajkowski, Short Hills, NJ (US)

Correspondence Address: MILBANK, TWEED, HADLEY & MCCLOY, 1 CHASE MANHATTAN PLAZA, NEW YORK, NY, 10005-1413, US

(21) Appl. No.: 11/244,583

(22) Filed: Oct. 6, 2005

Related U.S. Application Data
(60) Provisional application No. 60/697,839, filed on Jul. 8, 2005.

(51) Int. Cl. G06Q 40/00

(52) U.S. Cl. 705/35

(57) ABSTRACT

In a system and method for net share settlement of a convertible bond, a company issues a convertible bond at a first date, the bond including at least a par value and a maturity date. At a second date that is after the first date and prior to the maturity date, a request to convert the convertible bond is received. It is determined whether at least one predetermined financial provision is satisfied. Responsive to the determination of whether the at least one predetermined financial provision is satisfied, either the request to convert the convertible bond is declined, wherein declining the request is not a default of the convertible bond, or the convertible bond is net share settled by providing par value of the bond in cash and providing stock for any in-the-money value of the convertible bond that is above the par value.

This application claims priority to U.S. Provisional Patent Application Ser. No. 60/697,839, filed Jul. 8, 2005, entitled METHOD AND SYSTEM FOR NET SHARE SETTLEMENT OF CONVERTIBLE BOND, the disclosure of which is incorporated herein by reference.

### BACKGROUND

The invention relates to the field of finance, and more particularly to the field of financing in the convertible bond market.

In traditional net share settlement of a convertible bond, the issuing company needs to settle par value of the bond in cash, and issue stock for any in-the-moneyness above par value. Net share settlement allows the issuer to get treasury stock accounting for the convertible bond. The relevant accounting literature defines net share settleable convertibles as “Instrument C” by EITF 90-19 (amended January, 2002). EITF 90-19 defers accounting interpretation to FAS 128. FAS 128 infers that Instrument C is similar to a bond+a warrant. Hence, treasury stock method of accounting is applicable to net share settleable convertibles. With traditional net share settlement, if investors or holders of the convertible bonds elect to convert the bonds before the normal maturity date, then the issuer's obligation to repay par value in cash drains liquidity from the issuer. This may raise concerns with lenders. The situation is different at the bond maturity date, because the maturity date of the convertible bond is known, and the issuer can plan to have sufficient cash funds available to repay the par value.

Systems and methods are needed that allow conversion before maturity if the payment of cash does not adversely impact liquidity of the company, and disallow the conversion without default in the event that the early conversion is not allowed.

The preceding description is not to be construed as an admission that any of the description is prior art relative to the present invention.

### SUMMARY OF THE INVENTION

The various aspects of the embodiments provide a system and method for net share settlement of a convertible bond. The system and method comprise issuing a convertible bond at a first date, the bond including at least a par value and a maturity date. The system and method further comprise receiving, at a second date that is after the first date and prior to a third date, a request to convert the convertible bond. The system and method further comprise determining whether at least one predetermined financial provision is satisfied. The system and method further comprise responsive to determining whether the at least one predetermined financial provision is satisfied, either declining the request to convert the convertible bond, wherein declining the request is not a default of the convertible bond; or net share settling the convertible bond by providing par value of the bond in cash and providing stock for any in-the-money value of the convertible bond that is above the par value.

In one aspect, the at least one predetermined financial provision is total indebtedness. In one aspect, the at least one predetermined financial provision is undrawn amount of credit facilities. In one aspect, the at least one predetermined financial provision is coverage charges. In one aspect, the at least one predetermined financial provision is a financial ratio. In one aspect, the at least one predetermined financial provision is non-default on other debt. In one aspect, the at least one predetermined financial provision leaves a company issuing the convertible bond with a predetermined level of liquidity. In one aspect, the third date is the maturity date.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to an embodiment; and

FIG. 2 illustrates an example method according to an embodiment.

It is understood that the drawings are for illustration only and are not limiting.

### DETAILED DESCRIPTION OF THE DRAWINGS

Many companies issue convertible bonds to raise funds. Normally the convertible bonds are net share settleable so that the issuing company can take advantage of more favorable treatment under treasury stock accounting. In net share settlement, the issuing company pays the par value of the convertible bond in cash, and issues stock for any in-the-money value of the bond that is above the par value. When the conversion occurs at the normal maturity date of the convertible bond, the issuer knows the par value of the bonds, and how much cash is required. This makes it easy to plan for the expense.

However, most convertible bonds also include terms that allow a holder to ask for early conversion of the bond, in which case the issuer must pay the par value of the bond in cash and issue stock for any in-the-money value of the convertible bond. When a holder asks for such an early conversion, the issuing company may find it difficult to pay the par value in cash. If the company is unable to pay the par value in cash, the bond is technically in default, which creates rights for convertible bond holders and can adversely effect the ability of the issuing company to raise additional funds and may trigger other undesirable outcomes.

One possible solution for an issuing company is to limit early conversion prior to maturity. However, that is not a standard feature of convertible bonds, and investors would demand additional compensation (e.g. in the form of an additional coupon), thus making the convertible bond more expensive. Such a security would also have a more limited market appeal. This would limit investor interest and adversely impact trading in the secondary market when compared to similar securities without such a provision.

Another possible solution is that upon an early conversion the issuer delivers a bond (instead of cash) equivalent to the par value. However, this will have an adverse accounting treatment over the life of the security and may not be an attractive economic alternative for investors.

In the embodiments described below, the issuing company will settle the par value in cash only if the issuing company satisfies certain predetermined financial provisions, which will leave the issuing company in an adequate financial position (e.g., sufficient liquidity) after payment of the par value in cash.

Example System

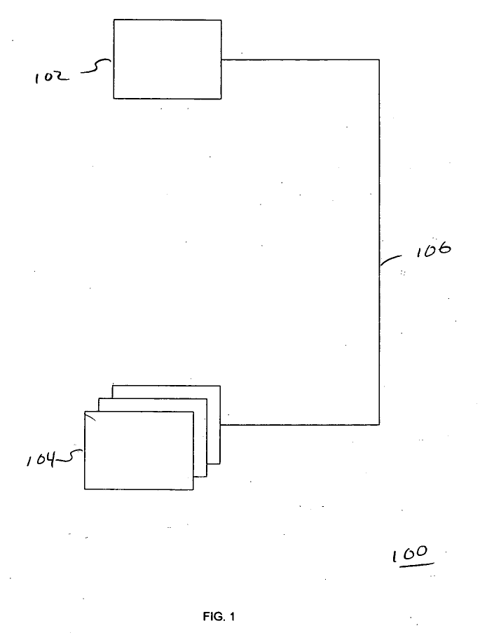

Referring to FIG. 1, an example system 100 includes an issuer of convertible bonds 102, and investors or holders of the convertible bonds 104. Although not illustrated, issuer 102 and holders 104 include computers with central processor units (CPUs), volatile and non-volatile memory (RAM, ROM, EPROM, flash, etc.), fixed and removable code storage devices (floppy drives, hard drives, memory sticks, tape, CD, DVD, etc.), input/output devices (keyboards, display monitors, printers, pointing devices, etc.), and network interface devices (Ethernet cards, WiFi cards, modems, etc.). Issuer 102 and holders 104 are interconnected by network 106, which may be a LAN, WAN, intranet, extranet, the Internet, the PSTN, etc. Computer executable software code is stored on the fixed and removable code storage devices, and is also transferred as an information signal, such as by download.

Example Method

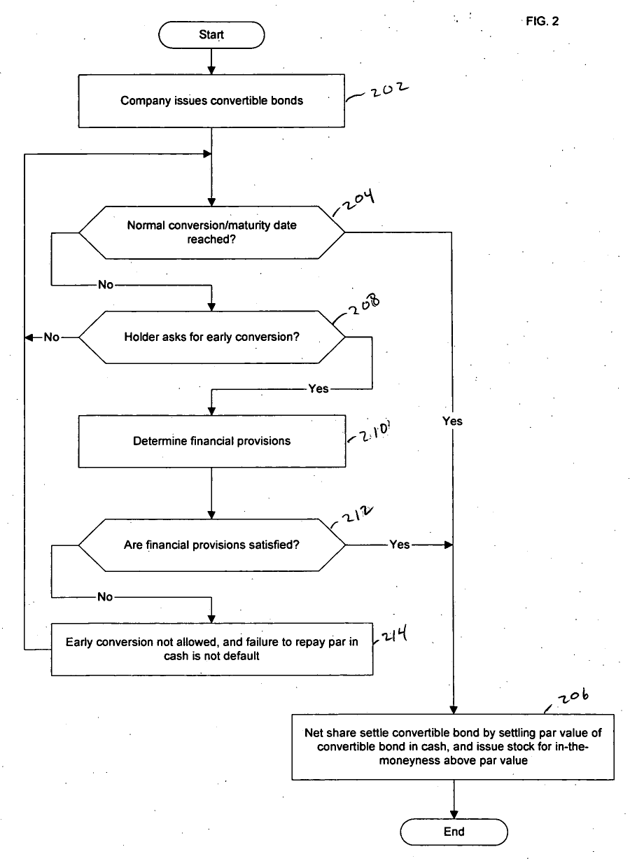

Referring to FIG. 2, at step 202 issuer 102 issues convertible bonds to the convertible bond market, where they are purchased by investors/holders 104. Among other terms, the convertible bonds have a par value and a maturity date. The convertible bonds also have a provision to net share settle the convertible bond at maturity. As part of the net share settlement, the holder is entitled to receive the par value in cash, and stock for any in-the-money value of the convertible bond. Those provisions apply to conversion at the maturity date. If the holder wants to redeem or convert the convertible bond prior to the maturity date, the holder is not necessarily entitled to receive par value in cash and stock for any in-the-money value of the convertible bond. Instead, the company must satisfy certain financial provisions related to a level of liquidity, which are described below.

At step 204, system 100 determines whether the normal conversion/maturity date of the convertible bond has been reached, and if so, at step 206 the bond is net share settled, with the holder receiving the par value of the convertible bond in cash, and stock for any in-the-money value of the convertible bond.

If at step 204, system 100 determines that the normal conversion/maturity date of the convertible bond has not been reached, then at step 208, system 100 determines whether any of holders 104 have asked for an early conversion of their convertible bonds.

If no holders have asked for early conversion, system 100 loops to step 204.

If at step 208, system 100 determines that any of holders 104 have asked for an early conversion of their convertible bonds, then at step 210, system 100 determines predetermined financial provisions of the issuing company.

These predetermined financial provisions and tests refer to total indebtedness, undrawn amount of credit facilities, coverage charges, and financial ratios.

As examples, the predetermined financial provisions might not permit payment with respect to any conversion if there is a default or event of default. Or, the provisions might not permit payment if payment of the settlement amount would prevent the issuer from meeting the financial ratios as specified in the credit facility. Of, the provisions might not permit payment if sufficient liquidity does not exist to pay any settlement amounts plus other future obligations in an amount greater than, or equal to 105% of the sum of: (i) any settlement amounts, where settlement amounts means, A) for notices delivered before a specific date, the principal amount of bonds surrendered for conversion, and B) for any notices delivered after a specific date, some predetermined amount less any principal amount of bonds that has been previously converted; (ii) next 12 months interest and principal payments; or (iii) expected next 12 months holding company expenses.

These predetermined financial provisions also include whether the issuing company has sufficient liquidity, or whether the issuing company satisfies certain financial ratios, or whether the issuing company is in default on other debt, etc.

At step 212, system 100 determines whether at least one of the predetermined financial conditions are satisfied. It is also possible that at step 212, system 100 determines whether more than one financial provision is satisfied, or whether all financial provisions are satisfied. It is also possible that system 100 determines whether any of the predetermined financial conditions are not satisfied.

If at step 212, system 100 determines that the predetermined financial provisions are satisfied, then at step 206, the requested early conversion of the convertible bond is allowed with a net share settlement. The holder receives the par value of the convertible bond in cash, and stock for any in-the-money value of the convertible bond.

If at step 212, system 100 determines that the predetermined financial provisions are not satisfied, then at step 214, system 100 declines the requested early conversion and loops to step 204. In this case, the company is not in a position to repay the par value in cash. However, failure to repay in cash is not a default (as would otherwise have been the case).

The embodiments described above help to preserve the appropriate and attractive treasury stock method of accounting for earnings per share and also prevents unplanned liquidity events and defaults. In addition, the embodiments do not require a further compensation in coupon or make the convertible bond less attractive.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for net share settlement of a convertible bond, the method comprising:
issuing a convertible bond at a first date, the bond including at least a par value and a maturity date;
receiving, at a second date that is after the first date and prior to a third date, a request to convert the convertible bond;
determining whether at least one predetermined financial provision is satisfied; and
responsive to determining whether the at least one predetermined financial provision is satisfied:
declining the request to convert the convertible bond, wherein declining the request is not a default of the convertible bond; or
net share settling the convertible bond by providing par value of the bond in cash and providing stock for any in-the-money value of the convertible bond that is above the par value.

2. A method according to claim 1, wherein the at least one predetermined financial provision is total indebtedness.

3. A method according to claim 1, wherein the at least one predetermined financial provision is undrawn amount of credit facilities.

4. A method according to claim 1, wherein the at least one predetermined financial provision is coverage charges.

5. A method according to claim 1, wherein the at least one predetermined financial provision is a financial ratio.

6. A method according to claim 1, wherein the at least one predetermined financial provision is non-default on other debt.

7. A method according to claim 1, wherein the at least one predetermined financial provision leaves a company issuing the convertible bond with a predetermined level of liquidity.

8. A method according to claim 1, wherein the third date is the maturity date.

9. A method for net share settlement of a convertible bond, the method comprising:
issuing a convertible bond at a first date, the bond including at least a par value and a maturity date;
receiving, at a second date that is after the first date and prior to the maturity date, a request to convert the convertible bond;
determining whether at least one predetermined financial provision is satisfied, the predetermined financial provision selected from the group including total indebtedness, undrawn amount of credit facilities, coverage charges, a financial ratio, and non-default on other debt, and wherein satisfying the at least one predetermined financial provision leaves a company issuing the convertible bond with a predetermined level of liquidity; and
responsive to determining whether the at least one predetermined financial provisions is satisfied:
declining the request to convert the convertible bond, wherein declining the request is not a default of the convertible bond; or
net share settling the convertible bond by providing par value of the bond in cash and providing stock for any in-the-money value of the convertible bond that is above the par value.

10. A system for net share settlement of a convertible bond, comprising:
means for issuing a convertible bond at a first date, the bond including at least a par value and a maturity date;
means for receiving, at a second date that is after the first date and prior to a third date, a request to convert the convertible bond;
means for determining whether at least one predetermined financial provision is satisfied; and
responsive to determining whether the at least one predetermined financial provision is satisfied:
means for declining the request to convert the convertible bond, wherein declining the request is not a default of the convertible bond; or
means for net share settling the convertible bond by providing par value of the bond in cash and providing stock for any in-the-money value of the convertible bond that is above the par value.

11. A computer-readable medium having computer executable software code stored thereon, the code for net share settlement of a convertible bond, the code comprising:
code to issue a convertible bond at a first date, the bond including at least a par value and a maturity date;
code to receive, at a second date that is after the first date and prior to a third date, a request to convert the convertible bond;
code to determine whether at least one predetermined financial provision is satisfied; and
responsive to determining whether the at least one predetermined financial provision is satisfied:
code to decline the request to convert the convertible bond, wherein declining the request is not a default of the convertible bond; or
code to net share settle the convertible bond by providing par value of the bond in cash and providing stock for any in-the-money value of the convertible bond that is above the par value.

12. Computer executable software code transmitted as an information signal, the code for net share settlement of a convertible bond, the code comprising:
code to issue a convertible bond at a first date, the bond including at least a par value and a maturity date;
code to receive, at a second date that is after the first date and prior to a third date, a request to convert the convertible bond;
code to determine whether at least one predetermined financial provision is satisfied; and
responsive to determining whether the at least one predetermined financial provision is satisfied:
code to decline the request to convert the convertible bond, wherein declining the request is not a default of the convertible bond; or
code to net share settle the convertible bond by providing par value of the bond in cash and providing stock for any in-the-money value of the convertible bond that is above the par value.

13. A programmed computer for net share settlement of a convertible bond, comprising:
a memory having at least one region for storing computer executable program code; and
a processor for executing the program code stored in the memory, wherein the program code comprises:
code to issue a convertible bond at a first date, the bond including at least a par value and a maturity date;
code to receive, at a second date that is after the first date and prior to a third date, a request to convert the convertible bond;
code to determine whether at least one predetermined financial provision is satisfied; and
responsive to determining whether the at least one predetermined financial provision is satisfied:
code to decline the request to convert the convertible bond, wherein declining the request is not a default of the convertible bond; or
code to net share settle the convertible bond by providing par value of the bond in cash and providing stock for any in-the-money value of the convertible bond that is above the par value.
